(19) United States
(12) Patent Application Publication
(10) Pub. No.: US 2019/0351609 A1
(43) Pub. Date: Nov. 21, 2019

(54) SUPPORTLESS PHOTORESIN 3D PRINTER

(71) Applicant: Abram Geoffrey Thau, Seattle, WA (US)

(72) Inventor: Abram Geoffrey Thau, Seattle, WA (US)

(21) Appl. No.: 16/416,975

(22) Filed: May 20, 2019

Related U.S. Application Data
(60) Provisional application No. 62/673,917, filed on May 20, 2018.

(51) Int. Cl. B29C 64/106; B29C 64/245; B29C 64/295; B29C 64/205; B29C 64/268

(52) U.S. Cl. CPC B29C 64/106; B29C 64/245; B33Y 30/00; B29C 64/205; B29C 64/268; B29C 64/295

(57) ABSTRACT

Provided is an apparatus for the creation of three dimensional objects by way of a layer-by-layer application of resin accompanied by temperature control and flashing by a light source. The temperature control associated with the apparatus allows for the three dimensional object to be created in the absence of any associated support structures. The dispenser used to apply each subsequent layer of resin is equipped with a heating element in order to raise the temperature of the resin upon deposition, while the build vat in which the object is being created is equipped with a cooling element in order to lower the temperature of the already-deposited layers in order to raise the viscosity to such a level that such already-deposited layers are capable of supplying adequate support to the object in order to sustain multiple layers of application.

This non-provisional application claims priority to U.S. Provisional Patent Application Ser. No. 62/673,917, filed on May 20, 2018.

### TECHNICAL FIELD

The present invention relates to a device and method for 3D printing. More specifically, the present invention provides for a photoresin 3D printer which is capable of creating objects in the absence of any associated support structures. Particularly, the present invention provides for a device and method for additive manufacturing which utilizes temperature control in conjunction with a curing means in order to construct an object according to a layer-by-layer application.

### BACKGROUND

3D printing, sometimes also referred to by the various different types thereof, such as additive manufacturing or rapid prototyping, is a fabrication technology in which three dimensional objects are created from a digital file, such as one generated from computer aided design (CAD) software or another similar 3D modeling program. One of the specific methods of additive manufacturing which is commonly used is that of a layer-by-layer application. The digital file of the desired 3D object is uploaded into the control system of the 3D printer, which is typically a computer or similar system. The 3D printer uses this digital file in order to create guide the layers of application. According to these types of methods, a polymerizable resin is applied incrementally according to these layers, with each subsequent layer being exposed to some external factor in order to achieve polymerization of the uppermost layer. Each of these layers consist of a thinly sliced, horizontal cross section of the completed product being manufactured.

One of the many problems posed by current 3D printing technology is the need for using a support structure in combination with the object being form. The support structure is used for any overhanging components of a 3D object. As an example, a molding or central component is used to anchor or tether any overhanging parts which may emanate from the central component. When a layer is approaching which requires the need for a corresponding support structure, the support structure must be included in those layers printed below or in advance of the overhanging components or portions of the 3D object in order to provide adequate support for the overhanging components. Not only can this need for associated support structures result in slowing down printing process, but it also can create the need to remove the formed object from, or dispose of, the support structure, which in turn adds even more time to the process. Certain support structures may further leave a residue or deposit behind on the object which is required to be polished or otherwise “cleaned” from the outer surface of the formed object. Thus, a 3D printer which is able to completely eliminate the need for any associated support structures is needed.

Currently there are a number of solutions for 3D printing. Some of these solutions attempt to solve the problem of needing support material for steep angles and overhangs, but these solutions fail to meet the needs of the industry because they may also result in lower detail resolution, high cost, and/or higher difficulty of use for the user. Other solutions attempt to do this by using powder layers, but these solutions are similarly unable to meet the needs of the industry because of the associated difficulty in recovering unused material and the low quality of the final product. Still other solutions seek to use support scaffolds or gel, but these solutions also fail to meet industry needs because they create added difficulty in cleanly removing those support materials from the finished product.

It would be desirable to have a device that prints 3D object in resin at high resolution which does not risk failed prints due to inadequate support scaffolding. Furthermore, it would also be desirable to have a device that does so with no need for manual post-processing of the created object in order to remove support scaffolding and sand away scarring left behind where the scaffolding has been cut away. Still further, it would be desirable to have a device that dramatically increases ease of use for the user through the lack of any need to orient the digital file so it can optimally accommodate support scaffolding. Therefore, there currently exists a need in the industry for a device and associated method that prints 3D objects at high resolution and detail in photoresin, without the need for support scaffolding generation in software, the physical curing of that scaffolding, and its tedious removal and cleanup.

### SUMMARY

The invention advantageously fills the aforementioned deficiencies by providing supportless photoresin 3D printing which provides a vastly simplified user experience with no need for support material.

Disclosed is a photoresin 3D printer, which is made up of the following components: a build vat, a cooling unit, a resin dispenser/spreader (typically a thin blade metal, plastic, or rubber), a horizontal linear motion axis, a laser or projector, a vertical linear motion axis, and control electronics. These components are connected as follows: the cooling unit chills the vat, the resin dispenser/spreader moves along the horizontal linear motion axis and wipes thin layers of resin across the bottom of the vat (and later across the previous layer of chilled resin which has been selectively cured), the laser or projector shines down into the vat to selectively cure the chilled resin, the vertical linear motion axis lowers and raises the vat in relation to the laser or projector, and the control electronics operate the moving axes and laser or projector.

The device may also have one or more of the following: a dehumidifying unit to control for condensation in the printer, a resin reservoir to feed the dispenser, a heater to maintain optimal temperature of the not yet dispensed resin, a heater to bring the chilled resin back up to a lower viscosity temperature after the printing process is complete, a pump to remove the warmed resin from the vat after the printing process is complete, an integrated rinsing station (ideally with an ultrasonic cleaner) to remove uncured resin residue from the finished object, an automated rinse cycle to remove uncured resin residue from the finished object after the warmed resin has been removed (possibly with ultrasonic cleaner integrated into the vat), an automated drainage system to remove rinse fluid after the aforementioned rinsing, an integrated UV light post-curing station to achieve tack-free surface curing of the finished object, automated post curing of the finished object, an audible notification when the print process and/or rinse process begins/ends, an integrated network connected computer to allow for remote operation of the printer and remote notification of print progress (such as via an app or text message). Similarly, the associated method may also include one or more of the following steps: fully automated warming of stored resin, automated recovery of uncured resin from the vat at the end of a print, automated rinsing of finished printed objects, automated post curing of a finished printed objects, and remote control of the printing process via network connection.

The disclosed device provides for a number of advantages over similar apparatuses currently known in the art. For example, the apparatus of the present disclosure provides for the ability to create high resolution 3D prints without the hassle of support structures or powder cleanup, has the ability to densely pack multiple high resolution printed objects into a single print cycle without the use of support material, and provides automated post-print cleanup by rinsing and post-curing the printed parts without the need for user involvement. The method of using the apparatus of the present disclosure similarly provides for numerous advantages over those currently known in the art, such as using chilled resin as a self-supporting layer-wise print material, thereby doing away with the necessity of dedicated support geometry or support material, and allowing for easy or automated recovery of uncured resin at the end of a print cycle. Similarly, the method of using the apparatus of the present disclosure, when compared with other known processes and solutions, provides for additional advantages in that it self-supports stacked print layers, similar to the manner in which a powder-based printing process operates, but with all the benefits of a resin 3D printing process (high resolution, easy recovery of uncured material, full reusability of that material, etc.) and none of the negative aspects of a powder-based approach (lower resolution, difficulty in recovering unused material after a print cycle, significantly degraded reusability of recovered material, etc.).

The disclosed device provides for structural advantages from other known devices or solutions. More specifically, the apparatus of the present disclosure provides for a vat chilling unit and a heated resin applicator/wiper blade. Furthermore, the process associated with the aforementioned device similarly provides for advantages over similar known processes. More specifically, the disclosed process of using the apparatus of the present disclosure warms resin before applying it as a new layer in the vat, chills resin deposited in the vat to cause that resin to become frozen solid or at least extremely viscous, uses that property of solidity or near-solid viscosity to fully support subsequent layers of resin, and warms the vat and contained cured and uncured resin at the end of a print in order to release the cured object from the surrounding uncured resin.

Further still, it is an object of the present invention to allow for 3D printing of objects with essentially arbitrary geometry and orientation. With all previous 3D printing techniques, objects with captive sections, deep pockets, or sections not accessible to manual cleanup make for very challenging prints as any support material in those difficult areas will be very troublesome to remove, whether that support material is plastic scaffolding, loose powder, or gel. With this invention, any shape can be printed, and the chilled, thickened resin which encapsulates the object during printing simply flows away at the end of the print process when it has been warmed.

The present invention relates to a device and a method associated with the device. With respect to the device, it is a photoresin based 3D printer, which creates physical objects from digital files, without the need for support material as is necessary in other photoresin 3D printers. This device can be used to create tangible objects by curing liquid or paste photoresin via laser or projector, in a self-supporting layer-by-layer process. The core components of the invention are the chilled build vat, the resin dispenser/spreader, the light source (laser or projector), the moving gantry to change the distance between the vat and light source, and the control hardware (computer), which, generally speaking, are configured as follows: the build vat is cooled to bring any resin deposited within it to a high level of viscosity (near solid), after which the resin dispenser/spreader lays down an initial layer of resin at the bottom of the vat, which is cooled on contact. Several layers of resin are deposited in this manner in order to create a buffer between the object to be created and the bottom of the vat. The light source cures a pattern into surface of the resin, according to the information provided by the digital model to be created. With the first layer completed, it is allowed to again cool down to optimal viscosity as the curing process generates heat. Once it is cooled, the moving gantry moves the vat and light source apart by the height of one layer, and a new layer of resin is deposited on top of the previously cured layer. This new layer is again selectively cured. That process repeats until all layers of the model have been deposited and cured. Once the physical model is complete, the vat is warmed in order to decrease the viscosity of any uncured resin, allowing for the removal of the finished part. With respect to the device it should be further noted that management of the resin viscosity via temperature is what allows for a lack of “support material,” as typically 3D printing software will have to add in scaffolding in and around the object to be created to support overhangs, steep angle, and fragile sections. By chilling the resin to increase its viscosity to near solidity, any uncured resin then acts as support for subsequent layers. With respect to the associated method, in order to carry out the method the following core steps are followed: new resin layer deposition and smoothing, chilling, curing, and lowering of the vat (or raising the light source). Ultimately, at the conclusion of these steps the printer has created a physical model formed of polymerized resin, with no extraneous support material to be removed.

The present disclosure provides for an apparatus for creating a three dimensional object. The apparatus consists of a resin storage, a build vat which is connected to the resin storage tank by way of a resin transportation tube, a build platform which is located within the build vat and is further capable of being either raised or lowered about a vertical motion axis, a dispenser which is affixed to one end of the resin transportation tube and capable of depositing resin in a layer-by-layer application onto the build platform of the build vat, with the dispenser having an associated heating element, a cooling element affixed to the build vat, a second heating element which is also affixed to the build vat, and a light source. The entire apparatus is configured with computer control hardware such that it is capable of being controlled easily and remotely based upon the desired dimensions and configurations of the objected being created according to a three dimensional automated drawing thereof.

The present disclosure further provides for a method of creating a three dimensional object. The method involves a first step of storing resin within a resin storage tank. The resin storage tank is connected to a build vat by a resin transportation tube which has a dispenser located at the opposing end. The dispenser is fed to a build vat, where it deposits resin that travels from the resin storage tank and through the resin transportation tube. The dispenser then deposits a first layer of resin on a build platform which is located inside the build vat. The dispenser has a heating element which is capable of raising the temperature of the resin inside the transportation tube upon being deposited. A cooling element in the build vat is then activated in order to lower the temperature of the deposited resin within the build vat. As the cooling element lowers the temperature of this already-deposited resin, the viscosity of this resin will increase, resulting in a solid or substantially-solid state. This substantially solid resin provides the necessary support for the object as it is being created according to the layered application of resin. A light source is then used to flash the newly deposited layer of resin. The light source provides a targeted light emission such that only that portion of the resin which is desired to be formed is subjected to enough light so as to fully polymerize. The height of the build platform is then adjusted accordingly such that the height of the object relative to the light source is appropriate for application of the subsequent layer of resin. Subsequent layers of resin are then applied on top of the previously deposited and flashed layer, with the dispenser heating the resin upon application. The light source is then used to flash this next layer, and the process continues until the object is completed.

An apparatus for the creation of a three dimensional object is disclosed. The apparatus comprises a resin storage tank. The resin storage tank is connected to a build vat by way of a resin transportation tube, where the build vat is comprised of four sidewalls which extend vertically upward and away from a based, creating an enclosure. Inside the enclosure is positioned a build platform which is capable of being raised and lowered about a vertical motion axis relative to the base of the build vat. A dispenser is affixed to one end of the resin transportation tube and capable of depositing a layer of resin onto the surface of the build platform. The dispenser is equipped with a spreader device which allows for the resin to be evenly smoothed into a layer about the surface of the build platform. The spreader device is a wiper arm blade which is able to move about a horizontal linear motion axis during application of the resin layer, and further equipped with a heating element which allows for the raising of the temperature of the resin during application. A cooling element is present in the build vat in order to lower the temperature of the already-deposited layers of resin. As the temperature of the already-deposited resin in the build vat decreases, the associated viscosity increases, resulting in resin which is solid or substantially solid and thereby capable of providing adequate support to the object as it is being constructed. A light source in the form of a laser is positioned above the build platform and capable of flashing the resin of the uppermost layer, thereby causing the resin to polymerize and take its final form. The build vat further has a heating element, which allows for the resin, following deposit and flashing of all layers, to be heated such that any excess resin undergoes a severe decrease in viscosity and is able to flow out of the build vat by way of a drain hose which connects to the resin storage tank. The flowing resin is substantially the same as that which was originally fed from the storage tank to the build vat, and thus may be intermixed with the “fresh” contents of the resin storage tank without any notable negative effects. A rinsing fluid storage tank is attached to the build vat by way of a rinsing fluid transportation tube, which allows for the introduction of a rinsing fluid into the build vat upon completion of the draining of any excess resin. Following the rinsing of the build vat, at least one ultrasonic transducer which is present in the build vat subjects the created object to significant agitation in order to continue the cleaning process. A post-curing UV light may further be present, either as part of the build vat, the light source, or as an independent component for subjecting the created object to one final curing application. The entire apparatus is configured with computer control hardware such that it is capable of being controlled easily and remotely based upon the desired dimensions and configurations of the objected being created according to a three dimensional automated drawing thereof.

This disclosure will now provide a more detailed and specific description that will make reference to the accompanying drawings. The drawings and specific descriptions of the drawings, as well as any specific or alternative embodiments discussed, are intended to be read in conjunction with the entirety of this disclosure. The Supportless photoresin 3D printer may, however, be embodied in many different forms and should not be construed as being limited to the embodiments set forth herein; rather, these embodiments are provided by way of illustration only and so that this disclosure will be thorough, complete, and fully convey understanding to those skilled in the art.

### BRIEF DESCRIPTION OF THE DRAWINGS

The accompanying drawings in the following description illustrate various embodiments of the present disclosure:

FIG. 1 shows a front view of the apparatus, with the build vat made transparent to show interior details;

FIG. 2 shows a side view of the apparatus, with the build vat made transparent;

FIG. 3 shows a downward slanted view of the resin applicator and wiper blade inside the build vat;

FIG. 4 shows a bottom view of the build vat; and,

FIG. 5 shows a side view of the vat and attached cooling unit.

### DETAILED DESCRIPTION

The apparatus of the present disclosure may include the following components: a resin storage tank, a rinse fluid storage tank, a build vat, a cooling unit, two heating units, a resin applicator/wiper blade, a resin depositor pump, two motorized linear axes, a laser and galvo system OR projector, control electronics, a resin evacuation pump, rinse fluid input and evacuation pumps, an ultrasonic cleaning unit, a UV post curing unit, and an enclosure. These components are connected as follows. The cooling unit is attached to the vat. A heating unit is attached to the wiper blade/resin pump assembly, which is itself attached to a motorized axis. The curing system (generally either a galvo directed laser, spinning mirror directed laser, OR projector) is positioned to shine down into the vat either directly or angled by mirrors. The second heating unit is also attached to the vat. A hose to a pump to drain resin back into the resin storage tank is positioned in or (integrated into) the vat. A different tube and pump connect that vat with the rinse fluid tank. The ultrasonic cleaning unit is attached to the vat. The UV post-curing unit is positioned above the tank. All of these subsystems are wired to the control electronics. Finally it should further be noted this setup is partially or fully contained within an enclosure, which is either opaque or consists of opaque and colored transparent sections and has a door for accessing the vat.

A method of using the apparatus of the present disclosure may consist of the following steps. The cooling unit lowers the temperature of the build vat in order to chill any resin deposited within. A heating unit raises the temperature of the pumped in resin in order to lower its viscosity for easier application by the wiper blade. The resin depositor pump moves resin from the storage tank and applies it to the warmed applicator/wiper blade, which then smooths the resin into the vat as a level layer by moving along the horizontal motorized linear axis. The resin is then chilled by the vat to freeze it, or vastly increase its viscosity. The curing system (typically either a directed laser OR projector OR possibly even a directed electron beam) then selectively solidifies a pattern into the deposited resin layer. The vat cooling system then brings the newly cured layer down to the temperature of the vat, as the curing process is generally exothermic and introduces unwanted heat. The vertical motorized linear axis then separates the curing system and vat by the height of one resin layer. The horizontal linear axis resets the wiper blade assembly's position in relation to the vat. This process repeats until all layers of the object have been applied to the vat and cured. Then the vat heating unit raises the temperature of the vat until the uncured resin within becomes less viscous, allowing a pump to drain that resin back into the resin storage tank for later reuse. The rinse pump then fills the vat with rinse fluid (typically water or isopropyl alcohol), and the ultrasonic cleaning unit agitates the fluid and printed objects in the vat to facilitate resin residue removal. The cleaning fluid is then pumped out of the vat, and the part is allowed to dry. The UV post-curing unit (ideally an array of UV or near-UV LEDs) then finalizes the surface cure of the part. This is all automated by the control electronics. Finally, it should further be noted that the exact temperatures to which the heating and cooling units warm and chill the resin are dependent on the particular chemistry of the resin used for that print, as different resins can be used for differing material properties of the finished printed part, and the precise chemical composition of the resin (choices of monomers, oligomers, photoinitiators, colorants, fillers, etc.) will all alter the temperatures needed to achieve the ideal viscosity for the various stages of the printing process described above. By lowering the temperature and therefore raising the viscosity of the resin, the resin becomes nearly solid. This allows subsequent layers of resin to be deposited and cured on top of previous layers, without the cured sections falling through the uncured resin as would happen if the uncured resin were warmer and less viscous. This allows for resin based 3D printing without the need for support material or support scaffolding as is necessary in previous resin based 3D printing approaches.

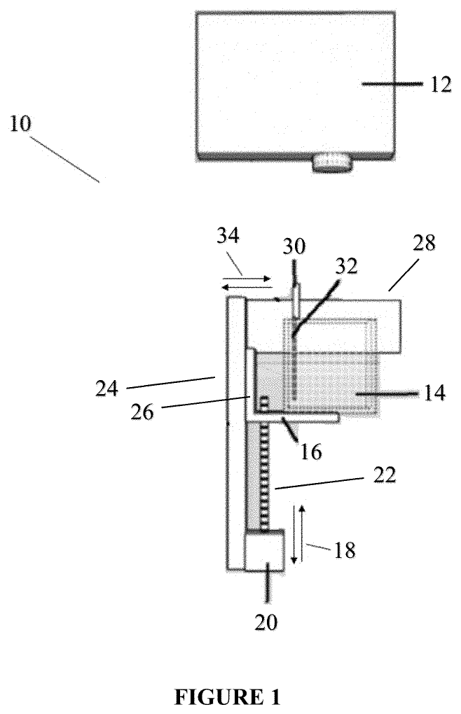

With reference now to FIG. 1, a 3D printing apparatus 10 is shown. Positioned about the top portion of the printing apparatus 10 is that of a light source 12. According to the embodiment shown in FIG. 1, the light source is a DLP projector. However, according to other embodiments, the light source may be a laser directed by moving mirrors as is common in laser/galvo apparatuses, a traditional laser printer, or any other device capable of providing sufficient light for the photo flashing techniques common in photoresin 3D printing apparatuses.

FIG. 1 shows a front view of the build vat 14. As shown in FIG. 1, the build vat 14 is transparent so as to allow for viewing of those component parts which may be located within that of the build vat 14. However, the material of construction of the build vat 14 may vary according to the desires of those having skill in the art. For example, a transparent build vat 14 may be used in order to allow for relative ease of monitoring the processes occurring within that of the build vat 14, or alternatively the build vat 14 may be constructed from a material which is completely opaque and does not allow for viewing, as well as any variations along the gradient of transparency. The build vat 14 is generally defined by a box-like configuration having a bottom support base and four sidewalls extending vertically upward and away from said support base. According to the embodiment shown in FIG. 1, the top face of the box-like configuration lacks any sort of covering, in that the face which is positioned opposite that of the support base and running parallel thereto is left open so as to allow access to the contents of the build vat 14.

With continued reference to FIG. 1, the build vat 14 is positioned on top of a traveling support carriage, or build platform 16, which moves vertically along linear motion axis 18 in order to increase or decrease the distance of the build vat 14 in relation to the light source 12. The build platform 16 is a substantially flat support base which aligns to run parallel to the support base of the build vat 14, thus providing for a relatively even and stable support surface therefore. Positioned beneath that of the build platform 16 is a base containing a first motor 20. The first motor 20 may be any configuration of drive motor and corresponding support shaft as identified by those having skill in the art, such as a servo motor or linear stepper motor with a corresponding ball screw or a belt and motor configuration. According to the embodiment shown in FIG. 1, the first motor 20 is configured with a corresponding first ball screw 22. The opposing end of the first ball screw 22 is affixed to the build platform 16 such that when the first motor 20 drives the first ball screw 22, the build platform 16 is capable of traversing about the vertical linear motion axis 18. This driving motion of the build platform 16 results in the build vat 14, located on the surface of the build platform 16, to be moved either closer to, or further away from, that of the light source 12 according to the driving action of the first motor 20.

As a means of providing structural support, a first support column 24 may run about the relative height of the printing apparatus 10 to which various components may be affixed. According to the embodiment shown in FIG. 1, first support column 24 is placed about the left-hand side of the printing apparatus 10. The first motor 20 is affixed to the bottom portion of the first support column 24, with the build platform 16 being positioned at a height located above. The build platform 16 may optionally have a backing plate 26 which extends upward and runs substantially parallel to that of the first support column 24 and forms a right angle with that of the surface of the build platform 16. Located above that of the build platform 16 may be a second support column 28 which runs substantially perpendicular to, and intersects with, the first support column 24. The second support column 28 extends horizontally away from that of the first support column 24 such that they form a right angle with one another, with the second support column 28 extending a distance beyond that of the length of the build platform 16.

With continued reference to FIG. 1, a dispenser or applicator may be affixed to the second support column 28. The dispenser or applicator is used to apply layers of resin which are retrieved from a resin storage tank. According to the embodiment shown in FIG. 1, the dispenser or applicator consists of an arm unit 30 which extends away from that of the second support column 28 on a first end, and a wiper blade 32 affixed to the opposing end. The arm unit 30 further connects the wiper blade 32 to that of the second support column 28 such that the entire unit is capable of traversing about a horizontal linear motion axis 34. The wiper blade 32 functions as a spreader device so as to evenly spread the freshly-deposited resin about the uppermost layer according to the contours of the object being created.

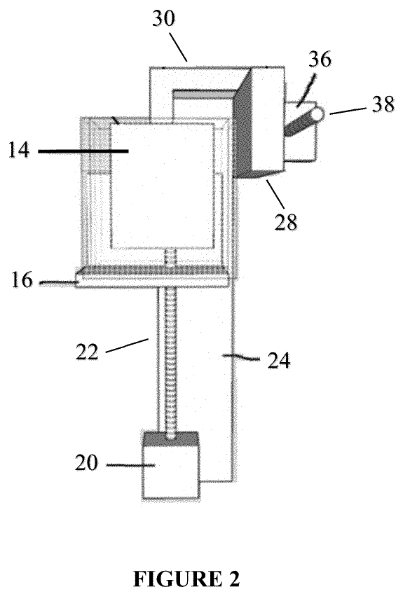

With reference to FIG. 2, the configuration of the second support column 28 and arm unit 30 is shown. The arm unit 30 is of an L-shaped design, extending away from that of the second support column 28 in a direction substantially parallel to that of the build platform 16, whereupon a 90 angle or bend is experienced wherein the arm unit 30 becomes substantially parallel to the second support column 28, or perpendicular to the build platform 16, and travels towards that of the build platform 16.

A second motor 36 and second ball screw 38, similar to the configuration of the first motor 20 and first ball screw 22, is able to drive the arm unit 30 so as to align the arm unit 30 and wiper blade 32 according to the desired specifications of the object being created. As resin is drawn from the resin storage tank (not shown) through a resin transportation tube, as will be discussed in greater detail with reference to the remaining FIGURES, the applicator arm unit 30 is able to dispense resin through the resin transportation tube and out of the wiper blade 32 onto the build platform 16 located within the build vat 14. In this way, a layer of resin can be deposited in the build vat 14 and wiped into a smooth layer by the horizontal linear motion axis 34 of the wiper blade 32. The light source 10 may then be activated to cure the appropriate cross-section for that layer. Following this curing by the light source 10, the build platform 16 is lowered about the vertical linear motion axis 18, and the wiper blade 32 is returned to its starting position about the horizontal linear motion axis 34, whereupon the above described process is repeated for a subsequent layer of resin application.

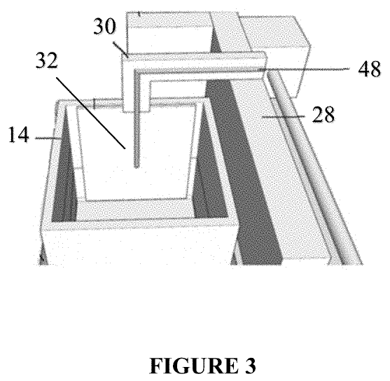

With reference now to FIG. 3, the resin transportation tube 48, which runs through the interior of the arm unit 30, can be seen. The resin transportation tube 48 allows a pump (not pictured) to move resin from a reservoir or tank (not pictured), such as a resin storage tank, through arm unit 30. The wiper blade 32 is positioned about the distal end of the resin transportation tube 48. As resin is transferred through the resin transportation tube 48 and out of the wiper blade 32 onto the build platform 16 located within that of the build vat 14, the wiper blade 32 moves about the horizontal linear motion axis so as to smooth the resin on a layer-by-layer basis. Affixed to the end of the wiper blade 32 is a first heating element 40. The first heating element 40 raises the temperature of the resin being transported via the resin transportation tube 48 immediately prior to depositing it into the build vat 14. As the temperature of the resin is raised, the viscosity is lowered, permitting the resin to flow more easily and thus be better manipulated by the wiper blade 32 for application.

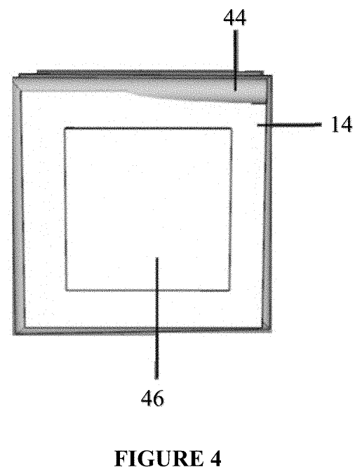

FIG. 4 shows an underside view of the build vat 14. Attached to the underside of build vat 14 may be a second heating element 46. After conclusion of the build process and when all layers of resin have been deposited into the build vat 14 onto the build platform 16, the second heating element 40 may be activated to raise the temperature of the remaining excess resin which has not been flashed or cured by the light source 10. As the remaining resin begins to heat up, this causes a lowering of the viscosity of the associated resin. All resin which remains uncured and therefore not a part of the completed object will be permitted to flow, and can therefore be drained from the build vat 14. According to the embodiment shown in FIG. 4, the second heating element 46 is a silicone pad resistance wire heater. However, additional embodiments may use various other types of heating elements, such as a heating coil or induction pad.

With continued referenced to FIG. 4, a cooling element may be associated with the build vat 14. The specific embodiment as shown in FIG. 4 utilizes a cooling coil 44 which is wrapped around the exterior of the build vat 14. The cooling coil 44 may further be a part of a vapor condensation cooling loop, but may also be any different number of cooling devices as identified by those having skill in the art, such as a Peltier cooler. The cooling coil 44 is activated upon the start of the process of forming a three dimensional object. As the heated resin is deposited according to a layer-by-layer application via the wiper blade 32, the cooling coil 44 causes a decrease in the temperature of the already-deposited layers of resin located within the build vat 14. As these already-deposited layers are cooled, the viscosity begins to increase. By cooling the contents of the build vat 14 to the required temperature based upon the specific properties of the resin being used, the already-deposited layers of resin will become solid or substantially solid based upon their elevated viscosity levels. According to an alternative embodiment, the cooling element is embedded into the walls of build vat 14 for a more compact overall device. Optionally, insulation may surround the entire assembly of the build vat 14, second heating element 46, and cooling coil 44 so as to increase the energy efficiency of the unit.

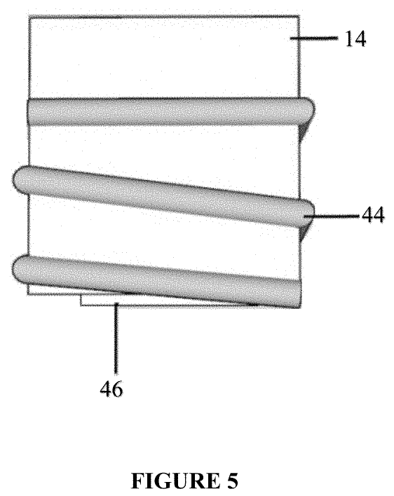

FIG. 5 shows a side view of the build vat 14. Attached to build vat 14 is a second heating element 46, which is here depicted as a silicone pad resistance wire heater, but others such as a heating coil or induction pad would suffice as well as identified by those having skill in the art. Cooling coil 44 is wrapped around build vat 14. While the particular embodiment as shown in FIG. 5 utilizes the cooling coil 44 as part of a vapor condensation cooling loop, numerous other types of cooling elements may be used so as to lower the temperature, and thereby raise the viscosity, of the resin located within the build vat 14, such as a Peltier cooler. Additionally, the cooling device could be embedded into the walls of build vat 14 for a more compact overall device. Optionally, insulation could surround the entire assembly of build vat 14, second heating element 46, and the cooling coil 44 in order to increase the power efficiency.

The various components of the 3D printer described above are capable of being controlled by a computer network. According to one embodiment, the various components are all part of a network which allows for their control and operation from a location remote from that of the apparatus. When a design is selected for creation, an automated drawing, such as a CAD drawing, of the design is uploaded to the network. This design thereby dictates the actions of the arm unit 30 and wiper blade 32 in depositing resin on a layer-by-layer basis. The light source 12 thus cures the resin according to the outline of the design which has been uploaded to the system.

The method of operating the apparatus herein described may generally proceed as follows. An automated drawing of an object to be created is uploaded into the network associated with the printing apparatus 10. The applicator begins drawing resin from the resin storage tank, which is transported through the resin transportation tube 48, which runs through the interior of the arm unit 30. Upon reaching the end of the arm unit 30 wherein the wiper blade 32 is positioned, the resin becomes heated by the first heating element 40. As the heated resin is deposited from the resin transportation tube 48 via the wiper blade 32, the arm unit 30 begins to traverse about the horizontal linear motion axis 34, driven by the combination of the second motor 36 and second ball screw 38. This horizontal linear motion allows for the resin to be deposited about a layer conforming to the design specifications as input in the automated drawing. As the arm unit 30 travels about the horizontal linear motion axis 34, the wiper blade 32 is able to physically interact with the resin and thereby smooth out the resin into the desired layering.

While the resin layer is being applied by the applicator, the cooling coil 44 of the build vat 14 is activated so as to decrease the temperature inside the build vat 14. This temperature decrease causes the resin deposited on the build platform 16 to increase in viscosity, resulting in a solid or substantially solid formation of resin. This substantially solid formation of resin thus provides support for the subsequent layers of resin to be applied. Once an individual layer of resin has been deposited, the light source 12 is activated so as to fully cure a targeted portion of resin. Once the layer of resin has been sufficiently cured, the height of the build platform 16 relative to the light source 12 is adjusted by the combination of the first motor 20 and first ball screw 22, which drive the build platform 16 away from that of the light source 12 in order to provide adequate space for subsequent layers of resin to be applied on top of that of the now-cured top layer. The steps of supplying the individual layers of resin, and subsequently curing them, are then repeated until the object has been completed.

As described above, the present disclosure has been described in association with various aspects thereof and it is understood that many changes and modifications to the described aspects can be carried out without departing from the scope and the spirit of the present disclosure that is intended to be limited only by the appended claims.

Having thus described the invention, it is now claimed:

What is claimed is:

1. An apparatus for the creation of a three dimensional object, comprising:
a resin storage tank;
a build vat connected to the resin storage tank by a resin transportation tube;
a build platform located inside the build vat capable of being raised and lowered about a vertical motion axis;
a dispenser affixed to one end of the resin transportation tube capable of depositing a layer of resin onto the build platform of the build vat, said dispenser having an associated first heating element;
a cooling element affixed to the build vat;
a second heating element affixed to the build vat; and,
a light source;
wherein computer control hardware is used to input the desired specifications of the three dimensional object being created and control the operation of the components comprising the apparatus.

2. The apparatus of claim 1, wherein the build vat is comprised of four sidewalls extending vertically upward and away from a base creating an enclosure therebetween.

3. The apparatus of claim 2, wherein the dispenser further comprises a spreader device.

4. The apparatus of claim 3, wherein the spreader device is a wiper blade having a first heating element.

5. The apparatus of claim 4, wherein the wiper blade is capable of traversing about a horizontal linear motion axis.

6. The apparatus of claim 5, wherein the light source is a laser.

7. The apparatus of claim 6, further comprising a first motor for driving the build platform about the vertical linear motion axis.

8. The apparatus of claim 7, further comprising a second motor for driving the wiper blade about the horizontal linear motion axis.

9. The apparatus of claim 8, further comprising a drainage hose connecting the built vat to the resin storage tank.

10. The apparatus of claim 9, further comprising a fluid transportation tube which connects the build vat to a rinsing fluid storage tank.

11. The apparatus of claim 10, further comprising at least one ultrasonic transducer capable of agitating the contents of the build vat.

12. A method of creating a three dimensional object, comprising the steps of:
storing resin in a resin storage tank, wherein the resin storage tank is connected to a build vat by a resin transportation tube having a dispenser located on at least one end;
selecting an automated file of a three dimensional object to be created and uploading said file to the computer control program of a printing apparatus;
depositing a first layer of resin by the dispenser on a build platform located inside the build vat, where the temperature of the resin is raised by a heating element positioned about the end of the dispenser;
activating a cooling element on the build vat to lower the temperature of the contents of said build vat;
flashing the layer of deposited resin with a light source;
adjusting the height of the build platform relative to the light source about a vertical linear motion axis; and,
depositing a second layer of resin on top of the first layer of resin, where the first layer has substantially solidified.

13. The method of claim 12, wherein the dispenser further comprises a spreader device being a wiper blade.

14. The method of claim 13, further comprising the step of the wiper blade traversing about a horizontal linear motion axis so as to evenly spread the resin being supplied by each layer.

15. The method of claim 14, wherein a first motor drives the build platform about the vertical linear motion axis.

16. The method of claim 15, wherein a second motor drives the wiper blade about the horizontal linear motion axis.

17. The method of claim 16, further comprising the step of activating a heating element of the build vat and draining any excess resin out of the build vat and into a resin storage tank.

18. The method of claim 17, further comprising the step of releasing a rinsing fluid into the build vat.

19. The method of claim 18, further comprising the step of draining the rinse fluid from the build vat and activating at least one ultrasonic transducer to agitate the contents of the build vat.

20. An apparatus for the creation of a three dimensional object, comprising:
a resin storage tank;
a build vat comprised of four sidewalls extending vertically upward and away from a base creating an enclosure therebetween, wherein the build vat is connected to the resin storage tank by a resin transportation tube;
a build platform located within the enclosure of the build vat capable of being raised and lowered about a vertical motion axis relative to the base of the build vat powered by a first motor;
a dispenser affixed to one end of the resin transportation tube capable of depositing a layer of resin onto the build platform of the build vat, wherein the dispenser further comprises a spreader device capable of spreading the deposited resin in a substantially even layer, where the spreader device is a wiper blade and capable of traversing about a horizontal linear motion axis powered by a second motor, said wiper blade having an associated first heating element capable of raising the temperature of the resin;
a cooling element affixed to the build vat capable of lowering the temperature of the contents of the build vat;
a second heating element affixed to the build vat capable of raising the temperature of the contents of the build vat;
a light source positioned above the build platform of the build vat, where the light source is a laser;
a drain hose connecting the build vat to the resin storage tank;
a rinsing fluid storage tank, wherein the rinsing fluid storage tank is connected to the build vat by a rinsing fluid transportation tube; and,
at least one ultrasonic transducer in the build vat capable of agitating the contents of the build vat;
wherein computer control hardware is used to input the desired specifications of the three dimensional object being created and control the operation of the components comprising the apparatus.
